(19) United States
(12) Patent Application Publication
(10) Pub. No.: US 2009/0033617 A1
(43) Pub. Date: Feb. 5, 2009

(54) Haptic User Interface

(75) Inventors: Phillip John Lindberg, Helsinki (FI); Sami Johannes Niemela, Helsinki (FI)

Correspondence Address: PERMAN & GREEN, 425 POST ROAD, FAIRFIELD, CT, 06824, US

(73) Assignee: NOKIA CORPORATION, Espoo (FI)

(21) Appl. No.: 11/832,914

(22) Filed: Aug. 2, 2007

(51) Int. Cl. G09G 5/00

(52) U.S. Cl. 345/156

(57) ABSTRACT

It is presented a method comprising: generating at least one haptic user interface component using an array of haptic elements; detecting user input applied to at least one haptic element associated with one of said at least one haptic user interface component; and executing software code associated with activation of said one of said at least one user interface component. A corresponding apparatus, computer program product and user interface are also presented.

### FIELD

The disclosed embodiments generally relate to user interfaces and more particularly to haptic user interfaces.

### BACKGROUND

User interfaces for users to control electronic devices have developed continuously since the first electronic devices. Typically, displays are used for output and keypads are used for input, particularly in the case of portable electronic devices.

There is however a problem with portable electronic devices, in that a user may desire to interact with the device even when it is not feasible to see the display.

One known way to alleviate this problem is to use voice synthesis and voice recognition. Voice synthesis is when the device outputs data to the user via a speaker or a headphones. Voice recognition is when the device interprets voice commands from the user in order to receive user input. However, there are situations when the user desires to be quiet and still interact with the device.

Consequently, there is a need for an improved user interface.

### SUMMARY

In view of the above, it would be advantageous to solve or at least reduce the problems discussed above.

According to a first aspect of the disclosed embodiments there has been provided a method comprising: generating at least one haptic user interface component using an array of haptic elements; detecting user input applied to at least one haptic element associated with one of the at least one haptic user interface component; and executing software code associated with activation of the one of the at least one user interface component.

Each of the at least one haptic user interface component may be generated with a geometrical configuration to represent the haptic user interface component in question.

The generating may involve generating a plurality of user interface components using the haptic element array, and wherein each of the plurality of user interface components may be associated with respective software code for controlling a media controller application.

The plurality of user interface components may be associated with the actions of: pausing media, playing media, increasing volume, decreasing volume, skip forward and skip back.

The generating may involve generating a user interface component associated with an alert.

The generating may involve generating user interface components associated with online activity monitoring.

A second aspect of the disclosed embodiment is an apparatus comprising: a controller; an array of haptic elements; wherein the controller is arranged to generate at least one haptic user interface component using the array of haptic elements; the controller is arranged to detect user input applied to at least one haptic element associated with the user interface component; and the controller is arranged to, as a response to the detection, execute software code associated with activation of the user interface component.

The apparatus may be comprised in a mobile communication terminal.

The controller may further be configured to generate each of the at least one haptic user interface component with a geometrical configuration to represent the haptic user interface component in question.

Each of the plurality of user interface components may be associated with respective software code for controlling a media controller application.

The plurality of user interface components may be associated with the actions of: pausing media, playing media, increasing volume, decreasing volume, skip forward and skip back.

A third aspect of the disclosed embodiments is an apparatus comprising: means for generating at least one haptic user interface component using an array of haptic elements; means for detecting user input applied to at least one haptic element associated with one of the at least one haptic user interface component; and means for executing software code associated with activation of the one of the at least one user interface component.

A fourth aspect of the disclosed embodiments is a computer program product comprising software instructions that, when executed in a controller capable of executing software instructions, performs the method according to the first aspect.

A fifth aspect of the disclosed embodiments is a user interface comprising: an array of haptic elements; wherein the user interface is arranged to generate at least one haptic user interface component using the array of haptic elements; the user interface is arranged to detect user input applied to at least one haptic element associated with the user interface component; and the user interface is arranged to, as a response to the detection, execute software code associated with activation of the user interface component.

Any feature of the first aspect may be applied to the second, third, fourth and the fifth aspects.

Other features and advantages of the disclosed embodiments will appear from the following detailed disclosure, from the attached dependent claims as well as from the drawings.

Generally, all terms used in the claims are to be interpreted according to their ordinary meaning in the technical field, unless explicitly defined otherwise herein. All references to “a/an/the [element, device, component, means, step, etc]” are to be interpreted openly as referring to at least one instance of the element, device, component, means, step, etc., unless explicitly stated otherwise. The steps of any method disclosed herein do not have to be performed in the exact order disclosed, unless explicitly stated.

### BRIEF DESCRIPTION OF THE DRAWINGS

The aspect of the disclosed embodiment will now be described in more detail, reference being made to the enclosed drawings, in which:

FIG. 1 is a schematic illustration of a cellular telecommunication system, as an example of an environment in which the disclosed embodiments may be applied.

FIGS. 2a-c are views illustrating a mobile terminal according to an embodiment.

FIG. 3 is a schematic block diagram representing an internal component, software and protocol structure of the mobile terminal shown in FIG. 2.

FIGS. 4a-b illustrate the use of a haptic user interface for media control that can be embodied in the mobile terminal of FIG. 2.

FIG. 5 illustrates the use of a user interface for alerts that can be embodied in the mobile terminal of FIG. 2.

FIG. 6 illustrates the use of a user interface for activity monitoring that can be embodied in the mobile terminal of FIG. 2.

FIG. 7 is a flow chart illustrating a method according to an embodiment that can be executed in the mobile terminal of FIG. 2.

### DETAILED DESCRIPTION OF EMBODIMENTS

The disclosed embodiments will now be described more fully hereinafter with reference to the accompanying drawings, in which certain embodiments of the invention are shown. This invention may, however, be embodied in many different forms and should not be construed as limited to the embodiments set forth herein; rather, these embodiments are provided by way of example so that this disclosure will be thorough and complete, and will fully convey the scope of the invention to those skilled in the art. Like numbers refer to like elements throughout.

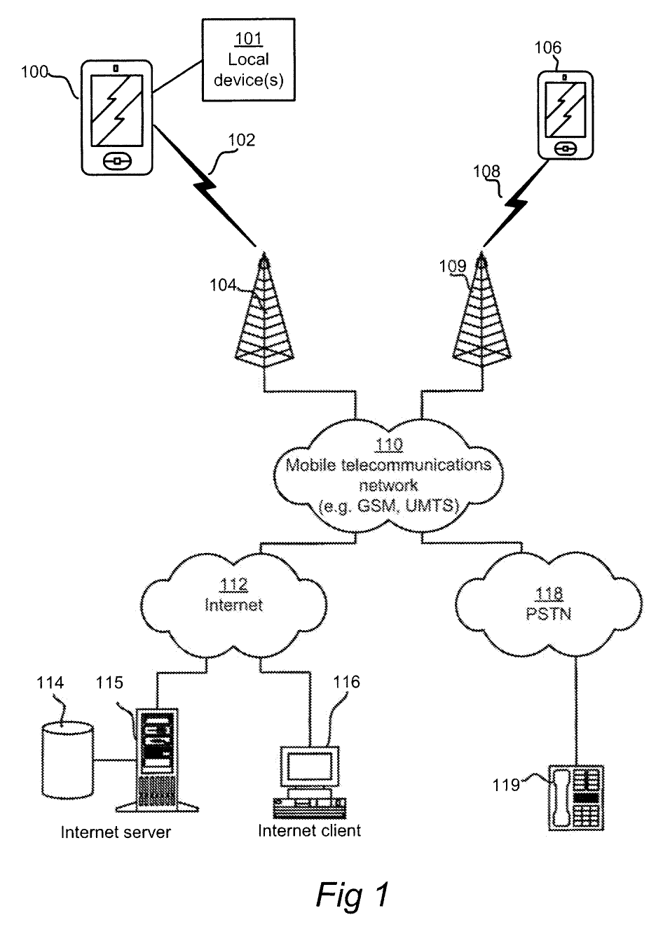

FIG. 1 illustrates an example of a cellular telecommunications system in which the invention may be applied. In the telecommunication system of FIG. 1, various telecommunications services such as cellular voice calls, www/wap browsing, cellular video calls, data calls, facsimile transmissions, music transmissions, still image transmissions, video transmissions, electronic message transmissions and electronic commerce may be performed between a mobile terminal 100 according to the disclosed embodiments and other devices, such as another mobile terminal 106 or a stationary telephone 119. It is to be noted that for different embodiments of the mobile terminal 100 and in different situations, different ones of the telecommunications services referred to above may or may not be available; the invention is not limited to any particular set of services in this respect. The mobile terminal 100 is connected to local devices 101, e.g. a headset, using a local connection, e.g. Bluetooth™ or infrared light.

The mobile terminals 100, 106 are connected to a mobile telecommunications network 110 through RF links 102, 108 via base stations 104, 109. The mobile telecommunications network 110 may be in compliance with any commercially available mobile telecommunications standard, such as GSM, UMTS, D-AMPS, CDMA2000, FOMA and TD-SCDMA.

The mobile telecommunications network 110 is operatively connected to a wide area network 112, which may be Internet or a part thereof. A server 115 has a data storage 114 and is connected to the wide area network 112, as is an Internet client computer 116.

A public switched telephone network (PSTN) 118 is connected to the mobile telecommunications network 110 in a familiar manner. Various telephone terminals, including the stationary telephone 119, are connected to the PSTN 118.

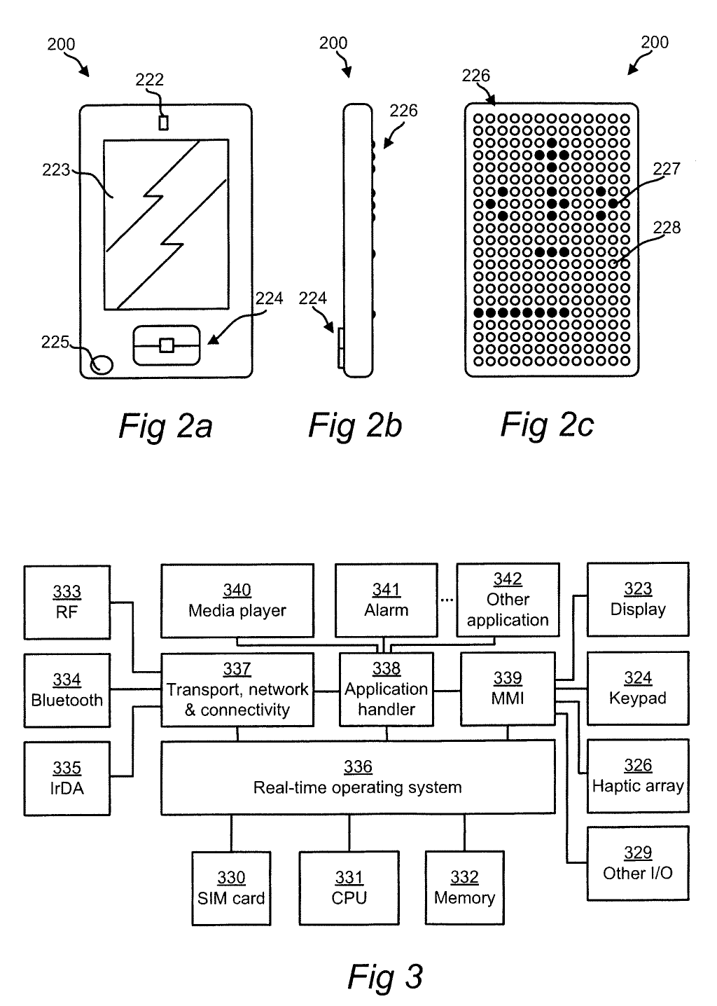

An front view of an embodiment 200 of the mobile terminal 100 is illustrated in more detail in FIG. 2a. The mobile terminal 200 comprises a speaker or earphone 222, a microphone 225, a display 223 and a set of keys 224.

FIG. 2b is a side view of the mobile terminal 200, where the keypad 224 can be seen again. Furthermore, parts of a haptic array 226 can be seen on the back of the mobile terminal 200. It is to be noted that the haptic array 226 does not need to be located on the back of the mobile terminal 200; the haptic array 226 can equally be located on the front face, next to the display 223 or on any of the side faces. Optionally, several haptic arrays 226 can be provided on one or more faces.

FIG. 2c is a back view of the mobile terminal 200. Here the haptic array 226 can be seen in more detail. This haptic array comprises a number of haptic elements 227, 228 arranged in a matrix. The state of each haptic element 227, 228 can be controlled by the controller (331 of FIG. 3) in at least a raised state and a lowered state. The haptic element 227 is in a raised state, indicated in FIG. 2c by a filled circle, and the haptic element 228 is in a lowered state, indicated in FIG. 2c by a circle outline. Optionally, as a further refinement, the haptic elements 227, 228 are controllable to states between the raised and the lowered states. As the user can feel the difference between a lowered and a raised element, output information can be conveyed to the user from the controller (331 of FIG. 3) by controlling the elements of the haptic array 226 in different combinations. Furthermore, user contact with haptic elements can be detected and fed to the controller (331 of FIG. 3). In other words, when the user presses or touches one or more haptic elements, this can be interpreted as user input by the controller, using information about which haptic element the user has pressed or touched. The user contact with the haptic element can be detected in any suitable way, e.g. mechanically, using capacitance, inductance, etc. The user contact can be detected in each haptic element or in groups of haptic elements. Optionally, the user contact can be detected by detecting a change, e.g. in resistance or capacitance, between a haptic element in question and one or more neighboring haptic elements. The controller can thus detect when the user presses haptic elements, and also which haptic elements that are affected. Optionally, information about intensity, e.g. pressure, is also provided to the controller.

The internal component, software and protocol structure of the mobile terminal 200 will now be described with reference to FIG. 3. The mobile terminal has a controller 331 which is responsible for the overall operation of the mobile terminal and is preferably implemented by any commercially available CPU (“Central Processing Unit”), DSP (“Digital Signal Processor”) or any other electronic programmable logic device. The controller 331 has associated electronic memory 332 such as RAM memory, ROM memory, EEPROM memory, flash memory, hard drive, optical storage or any combination thereof. The memory 332 is used for various purposes by the controller 331, one of them being for storing data and program instructions for various software in the mobile terminal. The software includes a real-time operating system 336, drivers for a man-machine interface (MMI) 339, an application handler 338 as well as various applications. The applications can include a media player application 340, an alarm application 341, as well as various other applications 342, such as applications for voice calling, video calling, web browsing, messaging, document reading and/or document editing, an instant messaging application, a phone book application, a calendar application, a control panel application, one or more video games, a notepad application, etc.

The MMI 339 also includes one or more hardware controllers, which together with the MMI drivers cooperate with the haptic array 326, the display 323/223, keypad 324/224, as well as various other I/O devices 329 such as microphone, speaker, vibrator, ringtone generator, LED indicator, etc. As is commonly known, the user may operate the mobile terminal through the man-machine interface thus formed. The haptic array 326 includes, or is connected to, electro-mechanical means to translate electrical control signals from the MMI 339 to mechanical control of individual haptic elements of the haptic array 326.

The software also includes various modules, protocol stacks, drivers, etc., which are commonly designated as 337 and which provide communication services (such as transport, network and connectivity) for an RF interface 333, and optionally a Bluetooth™ interface 334 and/or an IrDA interface 335 for local connectivity. The RF interface 333 comprises an internal or external antenna as well as appropriate radio circuitry for establishing and maintaining a wireless link to a base station (e.g., the link 102 and base station 104 in FIG. 1). As is well known to a person skilled in the art, the radio circuitry comprises a series of analogue and digital electronic components, together forming a radio receiver and transmitter. These components include, i.a., band pass filters, amplifiers, mixers, local oscillators, low pass filters, AD/DA converters, etc.

The mobile terminal also has a SIM card 330 and an associated reader. As is commonly known, the SIM card 330 comprises a processor as well as local work and data memory.

Now follows a scenario presenting a user interface according to an embodiment.

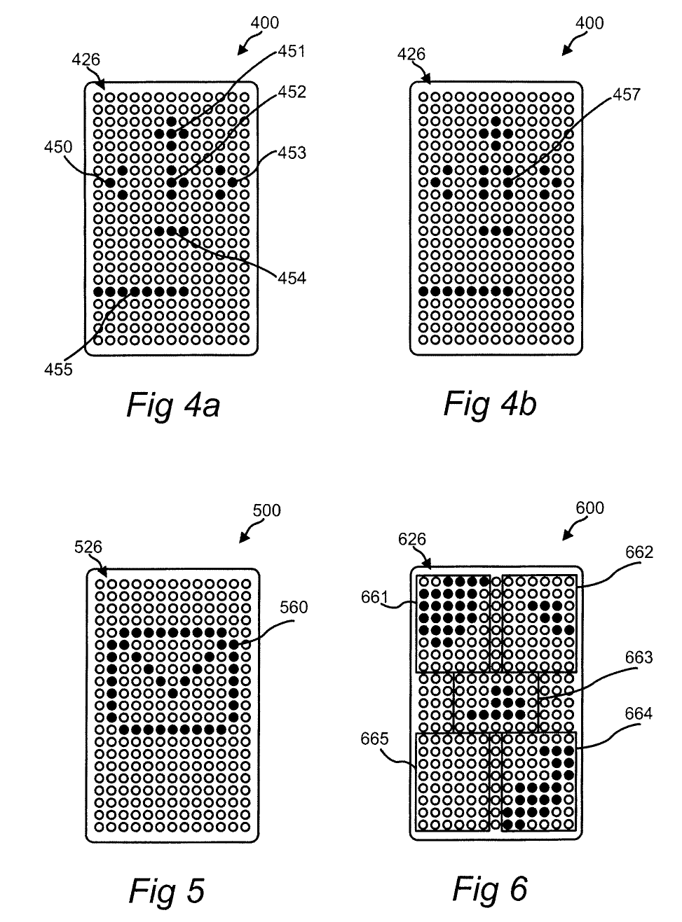

FIGS. 4a-b illustrate the use of a haptic user interface for media control that can be embodied in the mobile terminal of FIG. 2. User interface components are created by raising haptic elements of a haptic array 426 (such as the haptic array 226) of a mobile terminal 400 (such as the mobile terminal 200). Consequently, as seen in FIG. 4a, user interface components such as a “play” component 452, a “next” component 453, a “previous” component 450, a “raise volume” component 451, a “lower volume” component 454 and a “progress” component 455 are generated by raising corresponding haptic elements of the haptic array. The geometrical configuration, or shape, of the components correspond to conventional symbols, respectively. Optionally, the components can be generating by lowering haptic elements, whereby haptic elements not associated with user interface components are in a raised state, which could for example be used to indicate that the user interface is locked to prevent accidental activation. User pressure of these components can also be detected, whereby software code associated with the component is executed. Consequently, the user e.g. merely has to press the next component 453 to skip to a next track. This allows for intuitive and easy user input, even when the user can not see the display. If the user presses the play component 452, the media, e.g. music, starts playing and the haptic array 426 of the mobile terminal 400 changes to what can be seen in FIG. 4b. Here a pause component 457 has now been generated in a location where the play component 452 of FIG. 4a was previously generated. In other words, output is generated from the controller 331 corresponding to the state of the media player application, in this case shifting from a non-playing state in FIG. 4a to a playing state in FIG. 4b. Because of the general and adaptive nature of the matrix style haptic array, the haptic array 426 can be used for any suitable output. The mobile terminal 400 can thereby provide output to, and receive input from, the user, allowing the user to use the mobile terminal using only touch. Although the haptic elements are here presented in a matrix, any suitable arrangement of haptic elements can be used.

FIG. 5 illustrates the use of a user interface for alerts that can be embodied in the mobile terminal of FIG. 2. Here, an alert 560 is generated on the haptic array 526 (such as haptic array 226) of the mobile terminal 500 (such as mobile terminal 200). While in this example, the alert 560 depicts an envelope indicating that a message has been received, the alert can be any suitable alert, including a reminder for a meeting, an alarm, a low battery warning, etc. Optionally, when the user presses the alert 560 of the haptic array 526, a default action can be performed. For example, when the alert is a message alert, the mobile terminal 500 can output the message to the user using voice synthesis, such that the user can hear the message.

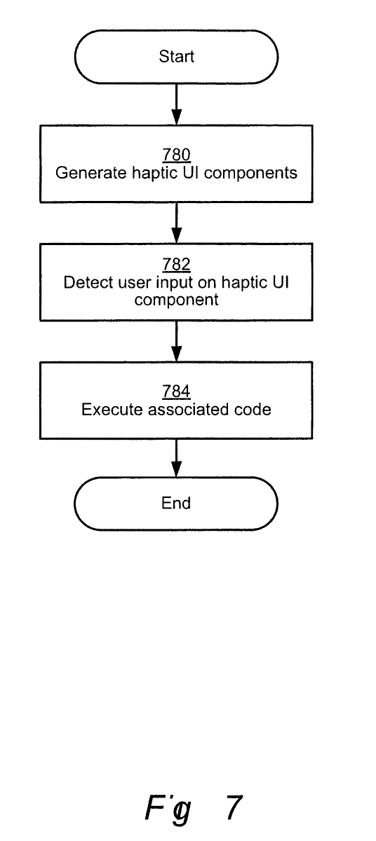

FIG. 6 illustrates the use of a user interface for online activity monitoring that can be embodied in the mobile terminal of FIG. 2. In this embodiment, different zones 661-665 are associated with different types of activity. The zones are mapped to various content channels to provide the user with the ability to monitor activity in blind-use scenarios. For example, in this embodiment, the centre zone 663 is associated with messages from personal contacts, the top left zone 661 is associated with MySpace® activity, the top right zone 662 is associated with Flickr™ activity, the bottom right zone 664 is associated with Facebook activity and the bottom left zone 665 is associated with a particular blog activity. The zones can optionally be configured by the user. The activity information is received to the mobile terminal using mobile networks (110 of FIG. 1) and wide area network (112 of FIG. 1) from a server (115 of FIG. 1). For example, the protocol Really Simple Syndication (RSS) can be used for receiving the activity information. Optionally, when the user presses a user interface component in one of the zones 661-665, the mobile terminal 600 can respond by ouputting, using voice synthesis, a statement related to the user interface component in question. For example, if the user presses on the user interface component in the top right zone 664, which is associated with Flickr™, the mobile terminal 600 can respond by saying “5 new comments on your pictures today”. When the user interacts with the haptic elements (e.g. by pressing), this can optionally also generate metadata. This metadata can be used in the mobile terminal 600 or transmitted to the content source, stating that the user is aware of the content associated with the interaction and may have even consumed it. This adds valuable information, albeit low level, of metadata that supports communication and better alignment between the user and involved external parties.

FIG. 7 is a flow chart illustrating a method according to an embodiment that can be executed in the mobile terminal of FIG. 2.

In an initial generate haptic UI (user interface) components step 780, haptic user interface components are generated on the haptic array 226 of the mobile terminal 200. This can for example be seen in more detail in FIG. 4a referenced above.

In a detect user input on haptic UI component step 782, user input is detected using the haptic array. The details of this are described above in conjunction with FIG. 2c above.

In a execute associated code step 784, the controller executes code associated with the user input of the previous step. For example, if the user input is associated with playing music in the media player, the controller executes code for playing the music.

Although the invention has above been described using an embodiment in a mobile terminal, the invention is applicable to any type of portable apparatus that could benefit from a haptic user interface, including pocket computers, portable mp3-players, portable gaming devices, lap-top computers, desktop computers etc.

The invention has mainly been described above with reference to a few embodiments. However, as is readily appreciated by a person skilled in the art, other embodiments than the ones disclosed above are equally possible within the scope of the invention, as defined by the appended patent claims.

What is claimed is:

1. A method comprising:
generating at least one haptic user interface component using an array of haptic elements;
detecting user input applied to at least one haptic element associated with one of said at least one haptic user interface component; and
executing software code associated with activation of said one of said at least one user interface component.

2. The method according to claim 1, wherein each of said at least one haptic user interface component is generated with a geometrical configuration to represent the haptic user interface component in question.

3. The method according to claim 1, wherein said generating involves generating a plurality of user interface components using said haptic element array, and wherein each of said plurality of user interface components are associated with respective software code for controlling a media controller application.

4. The method according to claim 3, wherein said plurality of user interface components are associated with the actions of: pausing media, playing media, increasing volume, decreasing volume, skip forward and skip back.

5. The method according to claim 1, wherein said generating involves generating a user interface component associated with an alert.

6. The method according to claim 1, wherein said generating involves generating user interface components associated with online activity monitoring.

7. An apparatus comprising:
a controller;
an array of haptic elements;
wherein said controller is arranged to generate at least one haptic user interface component using said array of haptic elements;
said controller is arranged to detect user input applied to at least one haptic element associated with said user interface component; and
said controller is arranged to, as a response to said detection, execute software code associated with activation of said user interface component.

8. The apparatus according to claim 7, wherein said apparatus is comprised in a mobile communication terminal.

9. The apparatus according to claim 7, wherein said controller is further configured to generate each of said at least one haptic user interface component with a geometrical configuration to represent the haptic user interface component in question.

10. The apparatus according to claim 7, wherein each of said plurality of user interface components are associated with respective software code for controlling a media controller application.

11. The apparatus according to claim 10, wherein said plurality of user interface components are associated with the actions of: pausing media, playing media, increasing volume, decreasing volume, skip forward and skip back.

12. An apparatus comprising:
means for generating at least one haptic user interface component using an array of haptic elements;
means for detecting user input applied to at least one haptic element associated with one of said at least one haptic user interface component; and
means for executing software code associated with activation of said one of said at least one user interface component.

13. A computer program product comprising software instructions that, when executed in a controller capable of executing software instructions, performs the method according to claim 1.

14. A user interface comprising:
an array of haptic elements;
wherein said user interface is arranged to generate at least one haptic user interface component using said array of haptic elements;
said user interface is arranged to detect user input applied to at least one haptic element associated with said user interface component; and
said user interface is arranged to, as a response to said detection, execute software code associated with activation of said user interface component.
